(19) United States
(12) Patent Application Publication
(10) Pub. No.: US 2026/0196694 A1
(43) Pub. Date: Jul. 9, 2026

(54) Lithium Metal Anode, and Lithium Metal Battery Including the Same

(71) Applicant: SK On Co., Ltd., Seoul (KR)

(72) Inventors: Seong Jin PARK, Daejeon (KR); Yun Sun CHO, Daejeon (KR); Jae Hoon CHOI, Daejeon (KR)

(21) Appl. No.: 19/439,699

(22) Filed: Jan. 5, 2026

(30) Foreign Application Priority Data
Jan. 8, 2025 (KR) 10-2025-0002918

(51) Int. Cl. H01M 50/586; H01M 4/02; H01M 4/134; H01M 4/40; H01M 50/531

(52) U.S. Cl. CPC H01M 50/586; H01M 4/134; H01M 4/405; H01M 50/531; H01M 2004/027

(57) ABSTRACT

A lithium metal anode includes: a lithium metal layer; and a frame-shaped insulating layer disposed on an edge of one surface of the lithium metal layer and including an inner surface.

### CROSS-REFERENCE TO RELATED APPLICATION(S)

This patent document claims the priority and benefits of Korean Patent Application No. 10-2025-0002918 filed on Jan. 8, 2025, the disclosure of which is incorporated herein by reference in its entirety.

### TECHNICAL FIELD

The disclosure and implementations disclosed in this patent document generally relate to a lithium metal anode and a lithium metal battery including the same.

### BACKGROUND

Interest in electric vehicles (EVs) as a potential replacement for fossil fuel-powered vehicles, a major cause of air pollution, has continued to grow. Furthermore, the development of lithium secondary batteries, which are primarily used as power sources for EVs due to their high discharge voltage and output stability, has also been actively underway.

Lithium metal having a relatively high capacity (3860 mAh/g) and low redox potential (−3.04 V vs. SHE), has recently come to prominence as a promising anode material, and research has also been underway on lithium metal batteries, including such lithium metal anodes (LMAs).

However, the application of lithium metal as an anode presents a problem that the high reactivity of lithium metal causes persistent side reactions with electrolytes, resulting in the formation of an unstable film and poor lifespan characteristics. In particular, lithium dendrites, which are formed during battery charging and discharging, not only significantly reduce the battery's lifespan but may also cause rapid internal short circuits, which may lead to fires and explosions, and therefore, technologies for effectively controlling dendrites are required.

### SUMMARY

The present disclosure may be implemented in some embodiments to provide an anode capable of suppressing the growth of lithium dendrites.

The lithium metal anode and lithium metal battery of the present disclosure may be widely applied to devices within green technology fields, such as electric vehicles, battery charging stations, and other battery-powered solar and wind power generation. Furthermore, the lithium metal anode and lithium metal battery of the present disclosure may be used in eco-friendly electric vehicles, hybrid vehicles, or the like, ameliorating the effects of climate change by suppressing air pollution and greenhouse gas emissions.

In some embodiments of the present disclosure, a lithium metal anode includes: a lithium metal layer; and a frame-shaped insulating layer disposed on an edge of one surface of the lithium metal layer and including an inner surface.

The lithium metal layer may include an anode tab drawn out in one direction of the lithium metal layer.

The lithium metal anode may further include an anode current collector disposed on a surface opposite to one surface on which the lithium metal layer and the insulating layer are disposed.

The anode current collector may include an anode tab drawn out in one direction of the anode current collector.

The lithium metal anode may include: an anode current collector; a lithium metal layer disposed on the anode current collector; and a frame-shaped insulating layer disposed on an edge of the anode current collector, wherein the inner surface of the insulating layer and an outer surface of the lithium metal layer may be disposed to be in contact.

The anode current collector may include an anode tab drawn out in one direction of the anode current collector.

A thickness of the insulating layer in a height direction may be 50 to 200 μm.

A thickness of the insulating layer in a height direction of the insulating layer and a direction, perpendicular to a direction in which the anode tab is drawn out, may be 0.05 to 5 mm.

A thickness of the insulating layer in a direction in which the anode tab is drawn out may be 0.1 to 10 mm.

A thickness of the insulating layer in a height direction may be compressed by 1 to 50% at a pressure of 0.1 MPa to 2 MPa.

The insulating layer may include at least one selected from the group consisting of polyethylene (PE), polypropylene (PP), polysulfone (PS), polycarbonate (PC), polybutylene terephthalate (PBT), polytetrafluoroethylene (PTFE), polyphenylene sulfide (PPS), polyimide (PI), polyvinyl chloride (PVC), polyurethane (PU), silicone rubber, and butyl rubber.

In some embodiments of the present disclosure, a lithium metal battery includes: an anode; the above lithium metal anode; and an electrolyte disposed between the lithium metal anode and the cathode.

An outer surface of the cathode may be disposed to be in contact with the inner surface of the insulating layer.

The electrolyte may be at least one selected from the group consisting of a liquid electrolyte, a solid electrolyte and a semi-solid electrolyte.

### BRIEF DESCRIPTION OF DRAWINGS

Certain aspects, features, and advantages of the present disclosure are illustrated by the following detailed description with reference to the accompanying drawings.

FIGS. 1A to 1C are perspective views schematically illustrating a lithium metal anode according to an embodiment of the present disclosure;

FIGS. 2A to 2C are side views schematically illustrating a lithium metal anode according to an embodiment of the present disclosure;

FIGS. 3A to 3C are plan views schematically illustrating a lithium metal anode according to an embodiment of the present disclosure; and

FIGS. 4 and 5 are photographs of lithium metal anodes according to Example 1 and Comparative Example 1, respectively.

### DETAILED DESCRIPTION

Features of the present disclosure disclosed in this patent document are described by example embodiments with reference to the accompanying drawings.

Hereinafter, the present disclosure will be described in detail with reference to the accompanying drawings. However, these are merely illustrative and the present disclosure is not limited to the specific embodiments described by way of example.

### Lithium Metal Anode

A lithium metal anode 100 of the present disclosure includes an insulating layer 20, which may suppress dendrite growth on the anode by inducing uniform electrodeposition.

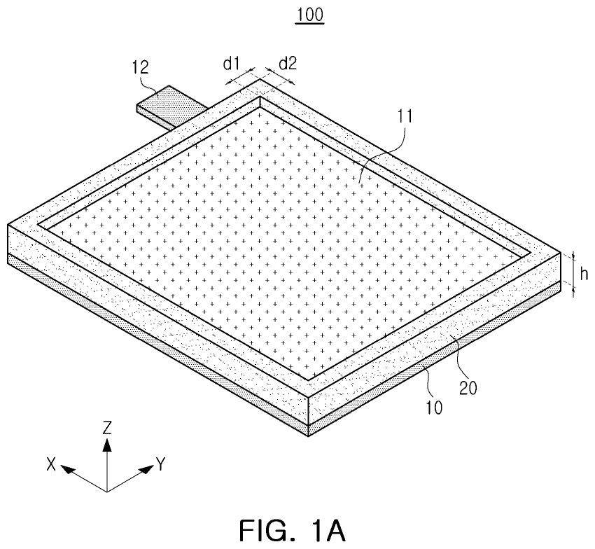

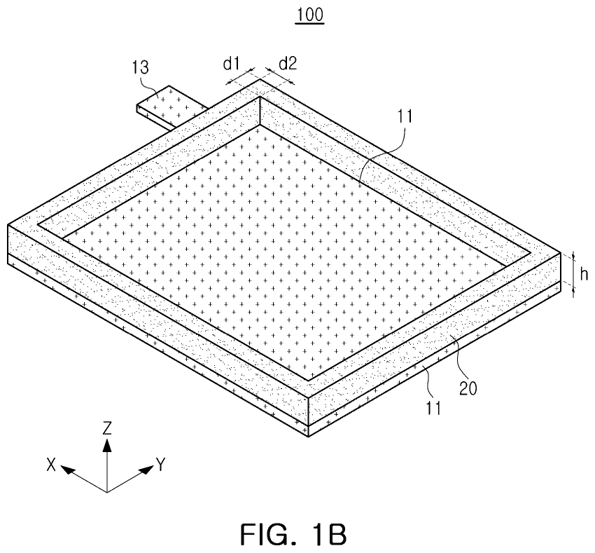

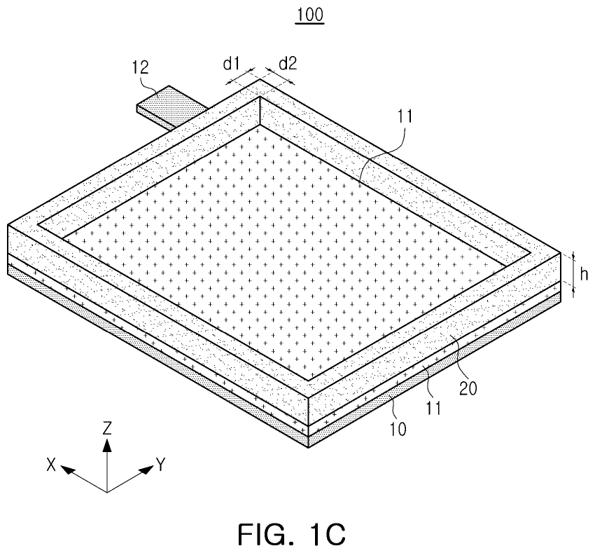

The lithium metal anode 100 of the present disclosure may include a lithium metal layer 11 and an insulating layer 20. FIGS. 1A to 1C are diagrams schematically illustrating the lithium metal anode 100 according to an embodiment of the present disclosure.

Specifically, FIG. 1B illustrate the lithium metal anode 100 according to an embodiment of the present disclosure. The lithium metal anode 100 according to an embodiment may include a lithium metal layer and the insulating layer 20 in the shape of a frame, disposed at the edge of one surface of the lithium metal layer and including an inner surface.

In the present disclosure, the “edge” may refer to an edge of an object. Furthermore, in the present disclosure, the “frame shape” may refer to a closed curve surrounding an object with a frame. For example, the frame shape may be a square, rectangle, circle, or oval, but the shape is not particularly limited.

Referring to FIGS. 1A to 1C, in the lithium metal anode 100 of the present disclosure, the height direction of the insulating layer 20 may be defined as the Z-axis direction, the direction, perpendicular to the height direction of the insulating layer 20 and the direction in which anode tabs 12 and 13 are drawn, may be defined as the Y-axis direction, and the direction in which the anode tabs 12 and 13 are drawn may be defined as the X-axis direction.

The lithium metal anode 100 according to an embodiment may not include an anode current collector 10 but may include a lithium metal layer 11, the anode tab 13, and the insulating layer 20. More specifically, the lithium metal anode 100 according to the present disclosure may have a structure not including a separate anode current collector 10 but including a lithium foil, which is a free-standing lithium metal layer 11.

Referring to FIG. 1B, the lithium metal anode 100 according to an embodiment may include the anode tab 13 drawn in one direction from the lithium metal layer 11. The anode tab 13 may be lithium metal.

FIGS. 1A and 1C illustrate the lithium metal anode 100 according to another embodiment of the present disclosure.

Referring to FIGS. 1A and 1C, an embodiment of the lithium metal anode 100 according to the present disclosure may include the anode current collector 10, the lithium metal layer 11, the anode tab 12, and the insulating layer 20. More specifically, the lithium metal anode 100 may be the lithium metal anode 100 in which the lithium metal layer 11 is disposed on the anode current collector 10.

Referring to FIG. 1C, the lithium metal anode 100 according to another embodiment may include the lithium metal layer 11 and the insulating layer 20 in the shape of a frame, disposed at the edge of one surface of the lithium metal layer 11 and including an inner surface. The lithium metal anode 100 may further include the anode current collector 10 disposed on the opposite side of the surface on which the lithium metal layer and the insulating layer 20 are disposed.

Referring to FIG. 1A, the lithium metal anode 100 according to another embodiment may include the anode current collector 10, the lithium metal layer 11 disposed on the anode current collector 10, and the insulating layer 20 in the shape of a frame disposed at the edge of the anode current collector 10. The insulating layer 20 may be disposed such that an inner surface of the insulating layer 20 is in contact with an outer surface of the lithium metal layer 11.

The insulating layer 20 may be in the shape of a frame, disposed at the edge of the lithium metal layer 11. The frame shape may be, for example, a rectangular frame but may be modified depending on the edge shape of the lithium metal layer 11 and is not particularly limited. For example, the insulating layer 20 may be formed in a frame shape so that the inner surface of the insulating layer 20 and the outer surface of a cathode, to be described below, are in contact to surround the cathode during the manufacture of a lithium secondary battery.

The lithium metal layer 11 may be lithium or a lithium alloy. The lithium alloy is an alloy of lithium and an element capable of alloying with lithium. The elements capable of alloying with lithium include, but are not limited to, one or more selected from the group consisting of Si, Sn, C, Pt, Ir, Ni, Cu, Ti, Na, K, Rb, Cs, Fr, Be, Mg, Ca, Sr, Sb, Pb, In, Zn, Ba, Ra, Ge, and Al.

The lithium metal layer 11 may be in the form of a sheet or foil. The lithium metal layer 11 may be formed by depositing or coating, for example, lithium or a lithium alloy on a current collector by a dry process or by depositing or coating lithium or a lithium alloy in particle form by a wet process, etc.

The thickness of the lithium metal layer 11 is not particularly limited and may range from 1 to 200 μm, for example.

Generally, lithium secondary batteries may be configured with a relatively larger anode than a cathode. In the lithium metal anode 100, an electron drift phenomenon, in which electrons drift toward the external surface of the lithium metal anode 100, may occur. Therefore, when a lithium secondary battery is charged, if lithium is deposited on the external surface (side surface) of the anode, which is outside the size of the cathode, due to the electron drift phenomenon, dendrites may grow on the external surface of the anode. Dendrite growth on the anode not only causes a short circuit in the battery, but also increases irreversible lithium, which may reduce the lifespan of the lithium secondary battery.

Accordingly, the lithium metal anode 100 of the present disclosure includes the insulating layer 20. The insulating layer 20 may suppress dendrite growth by inducing uniform electrodeposition of the lithium metal anode 100. During the charging process of the lithium secondary battery, the insulating layer 20 may prevent lithium from being deposited outside the anode, thereby inhibiting lithium deposition beyond the size of the anode, and accordingly, the insulating layer 20 may suppress the growth of lithium dendrites on the anode corresponding to the portion outside the cathode range, thereby preventing the end of lifespan of the lithium secondary battery due to a short circuit. Furthermore, the insulating layer 20 may mitigate the formation of inactive lithium during discharge of the lithium secondary battery, thereby improving the lifespan characteristics of the lithium secondary battery.

The insulating layer 20 may not absorb or react with a liquid or solid electrolyte, may not swell due to the electrolyte, and may not have electronic conductivity and ionic conductivity.

In addition, the thickness h of the insulating layer 20 in the height direction (the Z-axis direction) may be compressed by 1 to 50%, specifically 5 to 30%, and more specifically 5 to 20%, at a pressure of 0.1 to 2 MPa. When the insulating layer 20 may be compressed within the above range, voids existing at the lithium interface may be eliminated, and external pressure may be transmitted without loss, thereby suppressing dendrite growth.

The material of the insulating layer 20 is not particularly limited as long as the insulating layer 20 has the characteristics described above. For example, the insulating layer 20 may be a polyolefin-based polymer, such as low-density or high-density polyethylene, low-density or high-density polypropylene, an engineering polymer, such as polysulfone (PS), polycarbonate (PC), polybutylene terephthalate (PBT), polytetrafluoroethylene (PTFE), polyphenylene sulfide (PPS), or polyimide (PI), or a thermoplastic resin, such as polyvinyl chloride (PVC) or polyurethane (PU), or rubber, such as silicone rubber or butyl rubber, and may be formed of any one of the above materials or may be formed by mixing two or more thereof. Specifically, the insulating layer 20 may include at least one selected from the group consisting of polyethylene (PE), polypropylene (PP), polysulfone (PS), polycarbonate (PC), polybutylene terephthalate (PBT), polytetrafluoroethylene (PTFE), polyphenylene sulfide (PPS), polyimide (PI), polyvinyl chloride (PVC), polyurethane (PU), silicone rubber, and butyl rubber.

Referring to FIGS. 1A and 1C, the lithium metal anode 100 according to another embodiment of the present disclosure may include the anode current collector 10. For example, referring to FIG. 1C, the lithium metal anode 100 according to another embodiment may include the lithium metal layer 11 and the insulating layer 20 in the shape of a frame, disposed at the edge of one surface of the lithium metal layer and including an inner surface, and may further include the anode current collector 10 disposed on a surface opposite to the surface on which the lithium metal layer 11 and the insulating layer 20 are disposed. Referring to FIG. 1A, the lithium metal anode 100 of another embodiment may include the anode current collector 10, the lithium metal layer 11 disposed on the anode current collector 10, and the insulating layer 20 in the shape of a frame disposed at the edge of the anode current collector 10.

The anode current collector 10 is a current collector having appropriately excellent conductivity and adhesion to the lithium metal layer 11, etc., and the type, thickness, etc. thereof are not particularly limited. For example, the anode current collector 10 may be copper foil, nickel foil, stainless steel foil, titanium foil, nickel foam, copper foam, a polymer substrate coated with a conductive metal, or combinations thereof, and may have a thickness of 1 to 100 μm.

Referring to FIGS. 1A and 1C, the anode current collector 10 of the lithium metal anode 100 according to another embodiment of the present disclosure may include the anode tab 12 drawn out in one direction from the anode current collector 10. The anode tab 12 may be drawn out from one side of the anode current collector 10. The thickness and type of the anode tab 12 may be the same as those of the anode current collector 10.

In the lithium metal anode 100 according to another embodiment, the insulating layer 20 may be disposed on the edge of the lithium metal layer 11. For example, referring to FIG. 1A, the insulating layer 20 may be in the shape of a frame disposed on the edge of the lithium metal layer 11, and the anode current collector 10 may be disposed on a surface opposite to the surface on which the lithium metal layer 11 and the insulating layer are disposed. The frame shape may be, for example, a rectangular shape, but may vary depending on the edge shape of the lithium metal layer 11 and is not particularly limited. For example, the insulating layer 20 may be formed in a frame shape, such that the inner surface of the insulating layer 20 and the outer surface of a cathode, to be described below, are in contact to surround the cathode during the manufacture of a lithium secondary battery.

In another embodiment of the present disclosure, the insulating layer 20 may be disposed on the edge of the anode current collector 10. For example, referring to FIG. 1A, the insulating layer 20 may be disposed on the edge of the anode current collector 10, and may be disposed such that the inner surface of the insulating layer 20 and the outer surface of the lithium metal layer 11 are in contact. The insulating layer 20 may be in the shape of a frame. The shape of the frame may be, for example, a rectangular shape, but may be modified according to the shape of the edge of the anode current collector 10 and is not particularly limited. For example, the insulating layer 20 may be formed in the shape of a frame such that the inner surface of the insulating layer 20 and the outer surface of the cathode, to be described below, are in contact with each other to surround the cathode during the manufacture of a lithium secondary battery.

Referring to FIG. 1A, the width of the lithium metal layer 11 of the lithium metal anode 100 according to another embodiment of the present disclosure in the direction, perpendicular to the height direction (the Z-axis direction), may be narrower than the width of the anode current collector 10 in the direction, perpendicular to the height direction (the Z-axis direction).

In the lithium metal anode 100 of another embodiment, the lithium metal layer 11 may be disposed at the center of the anode current collector 10. The insulating layer 20 may be disposed at the edge portion of the anode current collector 10 in which the lithium metal layer 11 is not disposed.

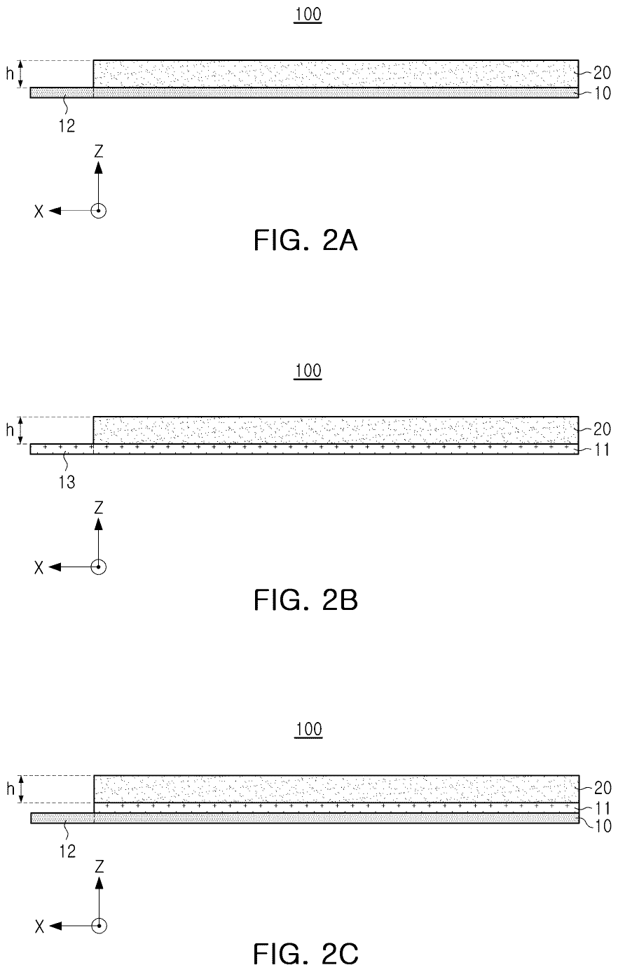

FIGS. 2A to 2C are schematic side views of the lithium metal anode 100 according to an embodiment of the present disclosure. Specifically, FIGS. 2A to 2C are side views of the lithium metal anode 100 of an embodiment of FIGS. 1A to 1C, respectively, viewed in the Y-axis direction. Referring to FIG. 2B, in the lithium metal anode 100 of an embodiment, the insulating layer 20 may be disposed on the lithium metal layer 11 and may not include the anode current collector 10. Referring to FIG. 2C, in the lithium metal anode 100 of an embodiment, it can be seen that the insulating layer 20 is disposed on the lithium metal layer 11. Referring to FIG. 2A, in the lithium metal anode 100 of an embodiment, the insulating layer 20 may surround the lithium metal layer 11.

Referring to FIGS. 1A and 2A, in an embodiment of the lithium metal anode 100 in which the insulating layer 20 surrounds the lithium metal layer 11, the thickness h of the insulating layer 20 in the height direction (the Z-axis direction) may be equal to the sum of the thickness of the anode in the height direction (the Z-axis direction) and the thickness of the lithium metal layer 11 in the height direction (the Z-axis direction).

Referring to FIGS. 1B and 1C and FIGS. 2B and 2C, in an embodiment of the lithium metal anode 100 in which the insulating layer 20 does not surround the lithium metal layer 11, the thickness h of the insulating layer 20 in the height direction (the Z-axis direction) may be equal to the thickness of the cathode in the height direction (the Z-axis direction).

Referring to FIGS. 1A to 1C and FIGS. 2A to 2C, in an embodiment, the thickness h of the insulating layer 20 in the height direction (the Z-axis direction) may range from 50 to 200 μm, specifically from 100 to 200 μm, and more specifically from 150 to 190 μm. If the thickness h of the insulating layer 20 in the height direction is less than 50 μm, dendrites may be formed on the side of the anode. If the thickness h of the insulating layer 20 in the height direction exceeds 200 μm, the proportion of the insulating layer 20 in the lithium secondary battery may increase, resulting in a decrease in electrode density.

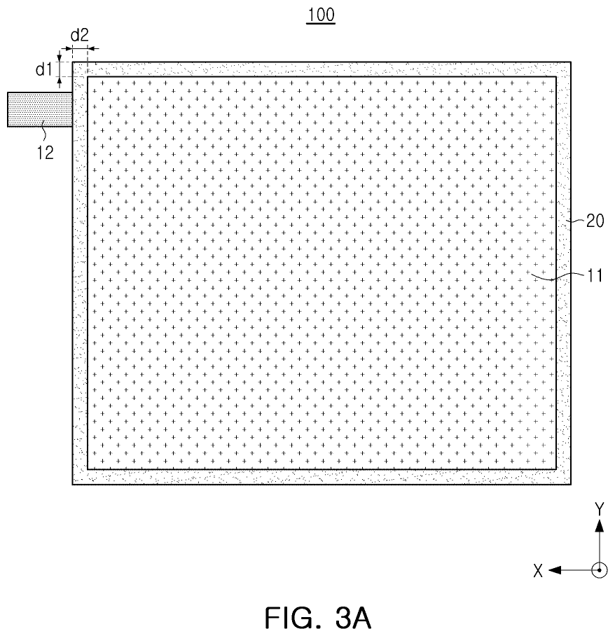

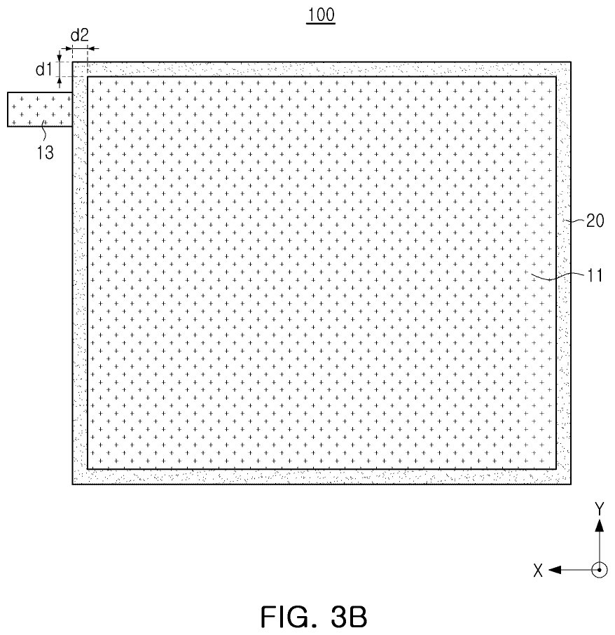

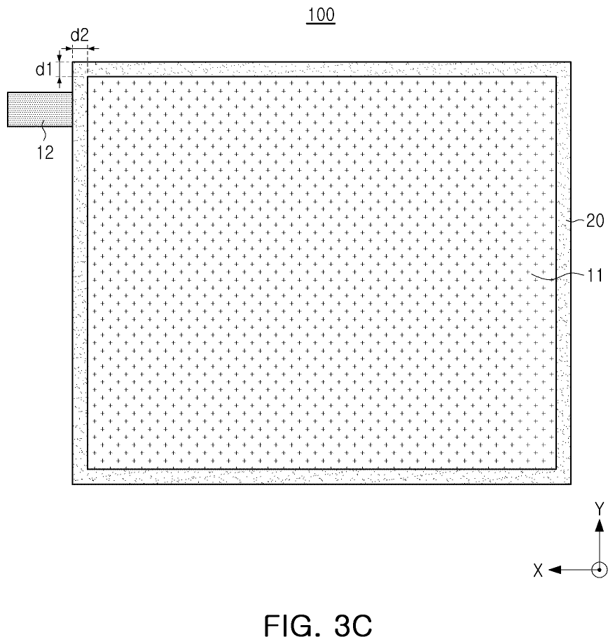

FIGS. 3A to 3C are plan views schematically illustrating the lithium metal anode 100 according to an embodiment of the present disclosure. Specifically, FIGS. 3A to 3C are plan views of the lithium metal anode 100 of an embodiment according to FIGS. 1A to 1C, respectively, viewed in the Z-axis direction.

The thickness d1 of the insulating layer 20 in the height direction of the insulating layer 20 and in the direction (the Y-axis direction), perpendicular to the direction in which the anode tab is drawn out, and the thickness d2 of the insulating layer 20 in the direction (the X-axis direction) in which the anode tabs 12 and 13 are drawn out may be the same as or different from each other. For example, the thickness d1 and the thickness d2 of the insulating layer 20 may be adjusted to suit the size of the cathode.

For example, referring to FIGS. 1A to 1C and FIGS. 3A to 3C, in an embodiment, the thickness d1 of the insulating layer 20 in the height direction of the insulating layer 20 and in the direction (the Y-axis direction), perpendicular to the direction in which the negative tab is drawn out, may be 0.05 to 5 mm, specifically 1 to 4 mm, and more specifically 2 to 3 mm. If the thickness d1 of the insulating layer 20 in the height direction of the insulating layer 20 and in the direction (the Y-axis direction), perpendicular to the direction in which the anode tab is drawn out, is less than 0.05 mm, the insulating layer 20 may not sufficiently contact the side surface of the cathode, resulting in the occurrence of a portion that the insulating layer 20 does not protect, potentially leading to the formation of dendrites on the side surface of the anode. Furthermore, if the thickness d1 of the insulating layer 20 exceeds 5 mm, the proportion of the insulating layer 20 in the lithium secondary battery may increase, resulting in a decrease in electrode density.

For example, referring to FIGS. 1A to 1C and FIGS. 3A to 3C, in an embodiment, the thickness d2 of the insulating layer 20 in the direction (the X-axis direction) in which the anode tabs 12 and 13 are drawn out, may be 0.1 to 10 mm, specifically 1 to 8 mm, and more specifically 3 to 7 mm. If the thickness d2 of the insulating layer 20 in the direction (the X-axis direction) in which the negative tabs 12 and 13 are drawn out is less than 0.1 mm, the insulating layer 20 may not sufficiently contact the side surface of the cathode, resulting in the occurrence of a portion that the insulating layer 20 does not protect. This may lead to the formation of dendrites on the side surface of the anode. Furthermore, if the thickness d2 of the insulating layer 20 exceeds 10 mm, the proportion of the insulating layer 20 in the lithium secondary battery may increase, resulting in a decrease in electrode density.

For example, the sum of the length of the cathode in the Y-axis direction and twice the thickness d1 of the insulating layer 20 may be equal to the length of the lithium metal anode 100 in the Y-axis direction.

For example, the sum of the length of the cathode in the X-axis direction and twice the thickness d2 of the insulating layer 20 may be equal to the length of the lithium metal anode 100 in the X-axis direction.

### Lithium Metal Battery

A lithium metal battery according to an embodiment may include the lithium metal anode 100 according to any of the embodiments described above. Specifically, the lithium metal battery may include the lithium metal anode 100, the cathode, and the electrolyte according to any of the embodiments described above and optionally may or may not include a separator. The outer surface of the cathode may be disposed to be in contact with the inner surface of the insulating layer 20.

The cathode may include a cathode current collector and a cathode composite layer disposed on at least one surface of the cathode current collector.

The cathode current collector may include stainless steel, nickel, aluminum, titanium, or alloys thereof. The cathode current collector may also include an aluminum surface-treated with carbon, nickel, titanium, or silver or a stainless steel surface-treated with carbon, nickel, titanium, or silver. The cathode current collector may have a thickness, for example, but not limited to, 10 to 50 μm.

The cathode current collector may take various forms, including, but not limited to, foil, foam, net, porous material, and non-woven fabric. Furthermore, the cathode current collector may have a thickness of 10 to 50 μm, but is not limited thereto.

According to embodiments, the cathode active material may include a lithium-nickel metal oxide. The lithium-nickel metal oxide may further include at least one selected from the group consisting of cobalt (Co), manganese (Mn), and aluminum (Al).

In some embodiments, cathode active material or the lithium-nickel metal oxide may have a layered structure or crystal structure represented by the Chemical Formula 1 below:

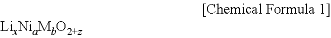

In Chemical Formula 1, 0.9≤x≤1.2, 0.6≤a≤0.99, 0.01≤b≤0.4, and −0.5≤z≤0.1. As described above, M may include Co, Mn, and/or Al.

The chemical structure represented by Chemical Formula 1 represents the bonding relationships within the layered or crystal structure of the cathode active material and does not exclude other additional elements. For example, M may include Co and/or Mn, and Co and/or Mn, along with Ni, may be provided as the main active elements of the cathode active material. Chemical Formula 1 is provided to express the bonding relationships of the main active elements and should be understood to encompass the introduction and substitution of additional elements.

In an embodiment, auxiliary elements may be included in addition to the main active elements to enhance the chemical stability of the cathode active material or the layered/crystal structure. These auxiliary elements may be incorporated into the layered/crystal structure to form bonds, and this should also be understood to fall within the chemical structure represented by Chemical Formula 1.

The auxiliary element may include, for example, at least one of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P, or Zr. The auxiliary element may also function as an auxiliary active element, such as Al, together with Co or Mn, contributing to the capacity/output activity of the cathode active material.

For example, the cathode active material or the lithium-nickel metal oxide may have a layered structure or crystal structure represented by the Chemical Formula 1-1 below:

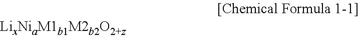

In Chemical Formula 1-1, M1 may include Co, Mn, and/or Al. M2 may include the auxiliary elements described above. In Chemical Formula 1-1, 0.9≤x≤1.2, 0.6≤a≤0.99, 0.01≤b1+b2≤0.4, and −0.5≤z≤0.1 may be satisfied.

The cathode active material may further include a coating element or a doping element. For example, elements substantially identical to or similar to the auxiliary elements described above may be used as the coating element or doping element. For example, the above-described elements may be used alone or in combination as a coating element or a doping element.

The coating element or doping element may be present on the surface of lithium-nickel metal composite oxide particles or may penetrate through the surface of the lithium-nickel metal composite oxide particles and be included in the bonding structure represented by Chemical Formula 1 or Chemical Formula 1-1.

The cathode active material may include a nickel-cobalt-manganese (NCM)-based lithium oxide. In this case, an NCM-based lithium oxide with an increased nickel content may be used.

Ni may be provided as a transition metal associated with the output and capacity of lithium secondary batteries. Therefore, by incorporating a high-Ni composition into the cathode active material, as described above, a high-capacity cathode and a high-capacity lithium secondary battery may be provided.

However, as the Ni content increases, the long-term storage stability and lifespan stability of the cathode or secondary battery may be relatively reduced and side reactions with the electrolyte may also increase. However, according to embodiments, the inclusion of Co may maintain electrical conductivity, while Mn may improve lifespan stability and capacity retention characteristics.

The Ni content (e.g., the mole fraction of nickel out of the total moles of nickel, cobalt, and manganese) in the NCM-based lithium oxide may be 0.6 or greater, 0.7 or greater, or 0.8 or greater. In some embodiments, the Ni content may be 0.8 to 0.95, 0.82 to 0.95, 0.83 to 0.95, 0.84 to 0.95, 0.85 to 0.95, or 0.88 to 0.95.

In some embodiments, the cathode active material may include a lithium cobalt oxide-based active material, a lithium manganese oxide-based active material, a lithium nickel oxide-based active material, or a lithium iron phosphate (LFP)-based active material (e.g., LiFePO₄).

In some embodiments, the cathode active material may include a manganese-rich active material, a lithium-rich layered oxide (LLO)/over-lithiated oxide (OLO)-based active material, or a cobalt-less active material, for example, having the chemical structure or crystal structure represented by Chemical Formula 2.

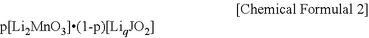

In Chemical Formula 2, 0<p<1, 0.9≤q≤1.2, and J may include at least one element selected from the group consisting of Mn, Ni, Co, Fe, Cr, V, Cu, Zn, Ti, Al, Mg, and B.

For example, a cathode slurry may be prepared by mixing the cathode active material in a solvent. The cathode slurry may be coated onto a cathode current collector, followed by drying and rolling to produce a cathode composite layer. The coating process may be performed using methods, such as gravure coating, slot die coating, multilayer simultaneous die coating, imprinting, doctor blade coating, dip coating, bar coating, and casting, but is not limited thereto. The cathode composite layer may further include a binder and optionally further include a conductive agent, a thickener, etc.

Non-limiting examples of solvents used in the preparation of the aforementioned cathode composite layer may include N-methyl-2-pyrrolidone (NMP), dimethylformamide, dimethylacetamide, N, N-dimethylaminopropylamine, ethylene oxide, tetrahydrofuran, etc.

The binder may include polyvinylidene fluoride (PVDF), vinylidene fluoride-co-hexafluoropropylene copolymer, polyacrylonitrile, polymethylmethacrylate, acrylonitrile butadiene rubber (NBR), polybutadiene rubber (BR), styrene-butadiene rubber (SBR), etc. In an embodiment, a PVDF-based binder may be used as the cathode binder.

The conductive agent may be added to enhance the conductivity of the cathode composite layer and/or mobility of lithium ions or electrons. For example, the conductive agent may include, but is not limited to, a carbon-based conductive agent, such as graphite, carbon black, acetylene black, Ketjen black, graphene, carbon nanotubes, vapor-grown carbon fiber (VGCF), carbon fiber, etc., and/or a metal-based conductive material, such as tin, tin oxide, titanium oxide, perovskite materials, such as LaSrCoO₃, LaSrMnO₃.

If necessary, the cathode composite layer may further include a thickener and/or a dispersant. In an embodiment, the cathode composite layer may include a thickener, such as carboxymethyl cellulose (CMC).

A separator may be interposed between the cathode and anode. The separator may be configured to prevent an electrical short-circuit between the cathode and anode and to allow ion flow. In some embodiments, the separator may have a thickness of 10 μm to 20 μm, but the present disclosure is not limited thereto.

For example, the separator may include a porous polymer film or a porous nonwoven fabric. The porous polymer film may include a polyolefin-based polymer, such as an ethylene polymer, a propylene polymer, an ethylene/butene copolymer, an ethylene/hexene copolymer, or an ethylene/methacrylate copolymer. The porous nonwoven fabric may include high-melting-point glass fibers, polyethylene terephthalate fibers, or the like. The separator may include a ceramic material. For example, inorganic particles may be coated on or dispersed within the polymer film to improve heat resistance.

The separator may have a monolayer or multilayer structure including the polymer film and/or the nonwoven fabric described above.

In a lithium metal battery as another embodiment of the present disclosure, the electrolyte may be at least one selected from the group consisting of a liquid electrolyte, a solid electrolyte, and a semi-solid electrolyte.

The electrode assembly may be accommodated within a case together with the electrolyte, thereby defining a lithium secondary battery. According to embodiments, a non-aqueous electrolyte may be used as the electrolyte.

The non-aqueous electrolyte may include a lithium salt as an electrolyte and an organic solvent. The lithium salt may be expressed as, for example, Li⁺X⁻, and the anion (X⁻) of the lithium salt may include, for example, F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, and (CF₃CF₂SO₂)₂N⁻.

The organic solvent may include an organic compound having sufficient solubility for the lithium salt and additives and being not reactive within the battery. The organic solvent may include, for example, at least one selected from the group consisting of carbonate solvents, ester solvents, ether solvents, ketone solvents, alcohol solvents, and aprotic solvents. As the organic solvent, for example, propylene carbonate (PC), ethylene carbonate (EC), butylene carbonate, diethyl carbonate (DEC), dimethyl carbonate (DMC), ethylmethyl carbonate (EMC), methylpropyl carbonate, ethylpropyl carbonate, dipropyl carbonate, vinylene carbonate, methylacetate (MA), ethyl acetate (EA), n-propylacetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), and 2-methyltetrahydrofuran, ethyl alcohol, isopropyl alcohol, dimethylsulfoxide, acetonitrile, diethoxyethane, sulfolane, gamma-butyrolactone, and propylene sulfite, etc. may be used. These may be used alone or in combination of two or more.

The non-aqueous electrolyte may further include additives. The additives may include, for example, cyclic carbonate compounds, fluorine-substituted carbonate compounds, sultone compounds, cyclic sulfate compounds, cyclic sulfite compounds, phosphate compounds, and borate compounds.

The cyclic carbonate compounds may include vinylene carbonate (VC), vinyl ethylene carbonate (VEC), etc.

The fluorine-substituted carbonate compounds may include fluoroethylene carbonate (FEC), etc.

The sultone compounds include 1,3-propane sultone, 1,3-propene sultone, and 1,4-butane sultone. The cyclic sulfate compounds may include 1,4-butane sulfone, etc.

The cyclic sulfate compounds may include 1,2-ethylene sulfate, 1,2-propylene sulfate, etc.

The cyclic sulfite compounds may include ethylene sulfite, butylene sulfite, etc.

The phosphate compounds may include lithium difluoro bis-oxalato phosphate, lithium difluoro phosphate, etc.

The borate compounds may include lithium bis(oxalate) borate, etc.

In some embodiments, a solid electrolyte may be used instead of the non-aqueous electrolyte described above. In this case, the lithium secondary battery may be manufactured in the form of an all-solid-state battery. In addition, a solid electrolyte layer may be disposed between the cathode and the anode instead of the aforementioned separator.

The solid electrolyte may include a sulfide-based electrolyte. As a non-limiting example, the sulfide-based electrolyte may include Li_{2S}—P₂S₅, Li₂S—P₂S₅—LiCl, Li₂S—P₂S₅—LiBr, Li₂S—P₂S₅—LiCl—LiBr, Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S—SiS₂—LiCl, Li₂S—SiS₂—B₂S₃—LiI, Li₂S—SiS₂—P₂S₅—LiI, Li₂S—B₂S₃, Li₂S—P₂S₅—ZmSn (m and n are positive numbers, Z is Ge, Zn, or Ga), Li₂S—GeS₂, Li₂S—SiS₂—Li₃PO₄, Li₂S—SiS₂—LipMOq, (p and q are positive numbers, M is P, Si, Ge, B, Al, Ga, or In), Li₇₋ₓPS₆₋ₓClₓ (0≤x≤2), Li₇₋ₓPS₆₋ₓBrₓ (0≤x≤2), Li₇₋ₓPS₆₋ₓIₓ (0≤x≤2), etc. These may be used alone or in combination of two or more.

In an embodiment, the solid electrolyte may include an oxide-based amorphous solid electrolyte, such as Li₂O—B₂O₃—P₂O₅, Li₂O—SiO₂, Li₂O—B₂O₃, Li₂O—B₂O₃—ZnO.

### EXAMPLE

Hereinafter, embodiments of the present disclosure will be further described with reference to specific Experimental Examples. Example and Comparative Example included in Experimental Examples are merely illustrative of the present disclosure and do not limit the scope of the appended claims. It will be apparent to those skilled in the art that various modifications and variations of the examples may be made within the scope and technical spirit of the present disclosure, and such modifications and variations are also within the scope of the appended claims.

### Manufacturing Example

### 1. Example 1

### (1) Manufacturing of Lithium Metal Anode

A lithium metal anode having an insulating layer was manufactured by adhering a PI film with a thickness of 75 μm in the height direction (the Z-axis direction) onto a copper current collector. Here, the thickness d1 of the insulating layer in the height direction and the direction (the Y-axis direction), perpendicular to the direction in which the anode tab is drawn out was 0.4 mm, and the thickness d2 of the insulating layer in the direction out (the X-axis direction) in which the anode tab is drawn out was 0.15 mm.

### (2) Manufacturing of Lithium Metal Battery

A cathode composition was obtained by mixing Li[Ni_{0.8}Co_{0.1}Mn_{0.1}]O₂, a conductive agent (Super-P; Timcal Ltd.), polyvinylidene fluoride (PVDF), and N-methyl-2-pyrrolidone. The weight ratio of Li[Ni_{0.8}Co_{0.1}Mn_{0.1}]O₂, the conductive agent, and PVDF in the cathode composition was 96:2:2.

The cathode composition was coated on aluminum foil (thickness: approximately 15 μm) and dried at 25° C. The dried result was then vacuum-dried at approximately 110° C. to manufacture the cathode. At this time, the thickness of the cathode was 55 μm, and the size of the cathode was (4.35 mm×4.8 mm).

A non-aqueous electrolyte was prepared by adding 5 wt % 4-fluoroethylene carbonate (based on the total weight of the electrolyte) to an organic solvent containing ethylene carbonate and ethyl methyl carbonate in a volume ratio (v/v) of 3:7 and dissolving lithium hexafluorophosphate (LiPF₆) (lithium salt) to a concentration of 1 M.

A 13 μm-thick porous polyethylene (PE) separator was interposed between the cathode and the anode, and the non-aqueous electrolyte was injected and sealed to prepare a pouch cell-type lithium metal battery.

### 2. Comparative Example 1

A lithium metal anode and a lithium metal battery were manufactured in the same manner as in Example 1, except that the insulating layer was omitted.

### Experimental Example

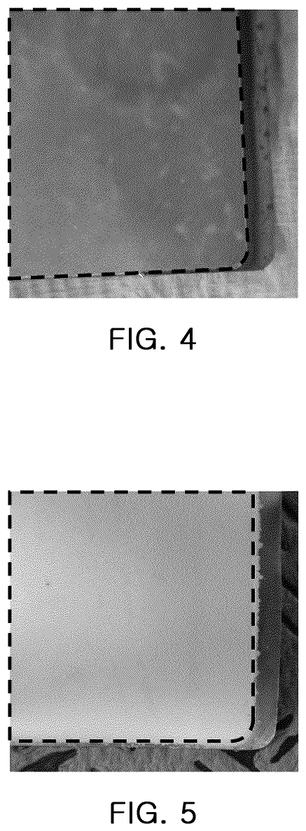

Charge/discharge tests were repeatedly performed (current density 2 mA/cm²) with the lithium metal batteries prepared in Example 1 and Comparative Example 1, the lithium metal battery was disassembled and measured by SEM to determine whether dendrites were formed on the surface of the anode. The results are shown in FIGS. 4 and 5.

As shown in FIG. 4, the lithium metal battery of Example 1 exhibited a uniform current density distribution, confirming that no dendrites were formed in a portion exceeding the size of the anode (black dotted line) on the side surface of the lithium metal anode.

As shown in FIG. 5, the lithium metal battery of Comparative Example 1 exhibited an uneven current density distribution, confirming that dendrites were formed in a portion exceeding the size of the anode (black dotted line) on the side surface of the lithium metal anode.

The anode according to an embodiment of the present disclosure may effectively suppress the growth of lithium dendrites.

The secondary battery including the anode according to an embodiment of the present disclosure may have improved cycle characteristics.

The above description is merely an example of applying the principles of the present disclosure, and other components may be included without departing from the scope of the present disclosure.

Only specific examples of implementations of certain embodiments are described. Variations, improvements and enhancements of the disclosed embodiments and other embodiments may be made based on the disclosure of this patent document.

What is claimed is:

1. A lithium metal anode comprising:
a lithium metal layer; and
a frame-shaped insulating layer disposed on an edge of one surface of the lithium metal layer and including an inner surface.

2. The lithium metal anode of claim 1, wherein the lithium metal layer includes an anode tab drawn out in one direction of the lithium metal layer.

3. The lithium metal anode of claim 1, wherein the lithium metal anode further includes an anode current collector disposed on a surface opposite to one surface on which the lithium metal layer and the insulating layer are disposed.

4. The lithium metal anode of claim 3, wherein the anode current collector includes an anode tab drawn out in one direction of the anode current collector.

5. The lithium metal anode of claim 1, wherein
the lithium metal anode includes:
an anode current collector;
a lithium metal layer disposed on the anode current collector; and
a frame-shaped insulating layer disposed on an edge of the anode current collector,
wherein the inner surface of the insulating layer and an outer surface of the lithium metal layer are disposed to be in contact.

6. The lithium metal anode of claim 5, wherein the anode current collector includes an anode tab drawn out in one direction of the anode current collector.

7. The lithium metal anode of claim 1, wherein a thickness of the insulating layer in a height direction is 50 to 200 μm.

8. The lithium metal anode of claim 2, wherein a thickness of the insulating layer in a height direction of the insulating layer and a direction, perpendicular to a direction in which the anode tab is drawn out, is 0.05 to 5 mm.

9. The lithium metal anode of claim 2, wherein a thickness of the insulating layer in a direction in which the anode tab is drawn out is 0.1 to 10 mm.

10. The lithium metal anode of claim 1, wherein a thickness of the insulating layer in a height direction is compressed by 1 to 50% at a pressure of 0.1 MPa to 2 MPa.

11. The lithium metal anode of claim 1, wherein the insulating layer includes at least one selected from the group consisting of polyethylene (PE), polypropylene (PP), polysulfone (PS), polycarbonate (PC), polybutylene terephthalate (PBT), polytetrafluoroethylene (PTFE), polyphenylene sulfide (PPS), polyimide (PI), polyvinyl chloride (PVC), polyurethane (PU), silicone rubber, and butyl rubber.

12. A lithium metal battery comprising:
an anode;
the lithium metal anode according to claim 1; and
an electrolyte disposed between the lithium metal anode and the cathode.

13. The lithium metal battery of claim 12, wherein an outer surface of the cathode is disposed to be in contact with the inner surface of the insulating layer.

14. The lithium metal battery of claim 12, wherein the electrolyte is at least one selected from the group consisting of a liquid electrolyte, a solid electrolyte and a semi-solid electrolyte.
